(19) United States
(12) Patent Application Publication
(10) Pub. No.: US 2022/0168688 A1
(43) Pub. Date: Jun. 2, 2022

(54) Separation and Recovery System and Method of Hydrogen from Coke Oven Gas (COG) in Steel Industry

(71) Applicant: Korea Research Institute of Chemical Technology, Daejeon (KR)

(72) Inventors: Jeong Hoon KIM, Daejeon (KR); Jong Yeol JEON, Daejeon (KR); Bo Ryoung PARK, Daejeon (KR); Ho Cheol KANG, Daejeon (KR)

(21) Appl. No.: 17/495,701

(22) Filed: Oct. 6, 2021

(30) Foreign Application Priority Data
Dec. 2, 2020 (KR) 10-2020-0166696

(51) Int. Cl. B01D 53/22; B01D 5/00; B01D 53/00; B01D 53/047

(52) U.S. Cl. CPC B01D 53/229; B01D 5/0003; B01D 53/002; B01D 53/228; B01D 2256/16; B01D 53/047; B01D 2253/108; B01D 2253/104; B01D 2253/102; B01D 53/226

(57) ABSTRACT

The present invention relates to a separation and recovery system and method of hydrogen from a coke oven gas (COG) in a steel industry, and more particularly, to a separation and recovery system and method of hydrogen from a coke oven gas (COG) in a steel industry, the system including a pre-processing unit removing impurities including tar, moisture, oil, hydrogen sulfide, and dusts from the coke oven gas (COG), a membrane separation unit including a polymer separation membrane module to generate a hydrogen concentrated gas stream by membrane-separating the coke oven gas (COG) processed in the pre-processing unit, and an adsorption unit separate and recover the hydrogen by allowing the hydrogen concentrated gas stream to contact an absorbent.

### CROSS-REFERENCE TO RELATED APPLICATIONS

This U.S. non-provisional patent application claims priority under 35 U.S.C. § 119 to Korean Patent Application No. 10-2020-0166696, filed on Dec. 2, 2020, the entire contents of which are hereby incorporated by reference.

### BACKGROUND

The present invention relates to a separation and recovery system and method of hydrogen with a high purity and a high recovery rate from a coke oven gas COG in a steel industry.

Hydrogen is a gas that is usable as a clean fuel because the hydrogen produces only water instead of causing pollution when reacts with oxygen of the air. Currently, the hydrogen is used only as an intermediate and a raw material of a product in a chemical industry and hardly used as a fuel of a fuel cell. However, as a hydrogen fuel cell technology is developed, related industries are reorganized to gradually replace a typical fossil fuel with the hydrogen as the fuel of the fuel cell. Thus, production, separation, and purification of the hydrogen and applied technology development become important.

In general, the hydrogen is produced by a method of reforming hydrocarbon such as a natural gas into vapor or a method of partially oxidizing a hydrocarbon containing material such as a fossil fuel or a biomaterial by using oxygen to produce a synthetic gas and then separating and recovering the synthetic gas. In addition to the hydrogen that is directly produced as described above, there is byproduct hydrogen produced as a by-product from oil refining and chemical industry. Naphtha cracking and all sorts of dehydrogenation processes in a petrochemical industry and a manufacturing process in an acid and alkali industry are representative process of producing the byproduct hydrogen. Most of the hydrogen and the byproduct hydrogen produced through a chemical reaction are currently used as a manufacturing material of an intermediate and a final product in the chemical industry, and only a portion thereof is distributed in a market. Since a distribution amount of the hydrogen is vastly insufficient to be used for the fuel cell, and also hydrogen having a high purity of 99.99% or more is required for the fuel cell, a new manufacturing method and a new separation and purification technology, which are different from a typical method, are required. Although a current price of the hydrogen is about 570 won/Nm³ based on a supply price of a hydrogen fueling state, it is expected that the price will be reduced to 400 won/Nm³, and eventually to 300 won/Nm³, according to a government policy for hydrogen economy revitalization. One of best methods for producing a large amount of high purity hydrogen at this price is a method of separating and recovering hydrogen contained in a coke oven gas (COG) that is a by-product produced from a steel mill with a high purity.

The coke oven gas (COG) is a gas produced in a process of manufacturing coke that is used as a reducing agent in a steel-manufacturing process. At least one hundred million tons of the coke oven gas (COG) is by-produced annually in the world, and about four to five hundred thousand tons of the coke oven gas (COG) is produced even in this country. As shown in table 1 below, since the coke oven gas (COG) contains hydrogen at about 56 vol %, about 50% of a hydrogen demand for the fuel cell may be theoretically covered when the hydrogen is recover with a high purity and a high recovery rate from the coke oven gas (COG).

### <Composition and Heating Value of Coke Oven Gas (COG)>

| Composition (vol %) | | | | | | Heating value |
|---|---|---|---|---|---|---|
| H₂ | CO | CO₂ | CH₄ | CₘHₙ | N₂ | (Kcal/Nm³) |
| 56.4 | 8.4 | 3.1 | 26.6 | 2.0 | 2.3 | 4,400 |

(source: Transactions of the Korean hydrogen and new energy society, vol. 13, no. 4, 339 (2002 December))

Also, the coke oven gas (COG) is a mixed gas having a complicated composition including 8.4% of carbon monoxide (CO), 2.3% of nitrogen (N₂), 3.1% of carbon dioxide (CO₂), 6.6% of methane (CH₄), and 2.0% of a hydrocarbon gas of C2 or more. In addition, since a small amount of impurities such as tar, oil, hydrogen sulfide (H₂S), and dusts are contained, a separation and purification technology of recovering hydrogen having a high purity of 99.99% from the coke oven gas (COG) at a low cost is required. However, due to the absence of the technology, currently, most of the coke oven gas (COG) is combusted as a material for power generation. Also, in this process, uncollected impurities causing atmospheric pollution may be combusted and discharged to the atmosphere. Thus, the separation and recovery process with low energy and a high efficiency is required to recover the hydrogen with a low cost from the coke oven gas (COG) mixed gas having multiple constituents, and when this technology is developed, the hydrogen produced from this technology may be used as a fuel of the fuel cell for power generation and vehicles and a chemical raw gas in the chemical industry.

A typical separating and purification technology of recovering the hydrogen from the coke oven gas (COG) includes a typical low temperature distillation method, a pressure swing adsorption (PSA), an absorbing method, and a membrane separation method.

However, when the low temperature distillation method is used, since the coke oven gas (COG) includes 56.4% of hydrogen having an extremely low liquefaction temperature and various constituents having various liquefaction temperatures such as carbon monoxide, carbon dioxide, and a light hydrocarbon gas, the low temperature distillation process requires much energy consumption and high plant purchasing and building costs. Thus, currently, a commercial plant for this process is not operated.

Also, when the pressure swing adsorption (PSA) is used, Japanese document on the pressure swing adsorption (PSA) for recovering the hydrogen from the coke oven gas (COG) by using an adsorbent of zeolite 5A (Journal of the Fuel Society of Japan, vol. 62, is.12, pp 989-994, 1983) discloses that a recovery rate is reduced to 60% or less when the hydrogen is purified at a purity of 99% to 99.99% by using a 2-bed (2-floor) adsorption tower. Recently, although a small size plant is demonstrated and operated in the US, Japan, China, and South Korea as the pressure swing adsorption (PSA) is applied to a steel by-product gas refining process, this pressure swing adsorption (PSA) operates a two-stage 4-bed PSA process of removing impurities such as tar, hydrogen sulfide, and dusts contained in the by-produced gas through pre-processing and then increasing a purity of the hydrogen to 90% in a 4-bed adsorption tower under a high pressure between 10 to 20 atmospheric pressure, and thereafter, refining the hydrogen again in a following connected 4-bed adsorption tower to increase the purity to 99.99%. The final recovery rate of the hydrogen is about 60% that is extremely low. Also, this PSA process is difficult to be precisely operated because adsorbents having various features are necessarily filled to adsorb and desorb carbon monoxide (CO), carbon dioxide (CO₂), nitrogen (N₂), and methane (CH₄). Furthermore, since the number and size of the adsorption tower increases in a gas recirculation process to increase the low hydrogen recovery rate of 60%, an economical efficiency is low to produce a large amount of hydrogen, and thus a necessity of technology improvement is still required.

A recent foreign thesis that compares and analyzes advantages and disadvantages of the pressure swing adsorption (PSA) and the membrane separation method on the commercial hydrogen separation and purification process reported that the membrane separation method has a high economical efficiency because the membrane separation method has a high recovery rate and requires low capital costs, low energy costs and low production costs although the purity of the hydrogen is rather low (NTP process technology, “hydrocarbon and methane reforming”, 30 Jan. 2018).

Thus, the inventors of the present invention develops a highly economical membrane separation-PSA mixed process, which is a mixed process of the membrane separation process and the pressure swing adsorption (PSA), of separating hydrogen with a high concentration from the coke oven gas (COG) by using the membrane process and then removing a small amount of impurities by the pressure swing adsorption (PSA), so as to recover the hydrogen having an overall high purity of 99.9% or more with a high recovery rate.

### RELATED ART DOCUMENT

### Non-Patent Document

Journal of the Fuel Society of Japan, 62(12), pp 989, 1983
NTP process technology, “hydrocarbon and methane reforming” 30 Jan. 2018

### SUMMARY

The present invention provides a separation and recovery system and method of hydrogen from a coke oven gas COG in a steel industry.

According to an aspect of the present invention, a separation and recovery system of hydrogen from a coke oven gas (COG) in a steel industry includes: a pre-processing unit configured to remove impurities including tar, moisture, oil, hydrogen sulfide, and dusts from the coke oven gas (COG); a membrane separation unit including a polymer separation membrane module to generate a hydrogen concentrated gas stream by membrane-separating the coke oven gas (COG) processed in the pre-processing unit; and an adsorption unit configured to separate and recover the hydrogen by allowing the hydrogen concentrated gas stream to contact an absorbent.

The membrane separation unit may include a plurality of separation membrane packages each including at least one polymer separation membrane module, and at least two separation membrane packages of the plurality of separation membrane packages may be connected in serial.

The membrane separation unit may have a circulation structure of re-supplying a gas stream discharged from a remaining side outlet of the separation membrane package disposed on a rear end of the separation membrane packages to a remaining side inlet of the separation membrane package disposed on a frontmost end of the separation membrane packages.

The separation membrane package may further include a compressor disposed on a front end of each of the separation membrane packages.

The compressor may compress the gas stream transferred to the separation membrane package at a pressure of 5 bar to 15 bar.

The polymer separation membrane module may include a polymer separation membrane configured to selectively separate the hydrogen from a mixed gas containing hydrogen, carbon monoxide, carbon dioxide, nitrogen, methane, and a light hydrocarbon gas.

The polymer separation membrane may be made of at least one kind selected from the group consisting of polysulfone, polyimide, and polybenzimidazole.

According to another aspect of the present invention, a separation and recovery method of hydrogen from a coke oven gas (COG) in a steel industry includes: a pre-processing process of removing impurities including tar, moisture, oil, hydrogen sulfide, and dusts from the coke oven gas (COG); a membrane separation process of generating a hydrogen concentrated gas stream by membrane-separating the coke oven gas (COG) processed in the pre-processing process by using a polymer separation membrane module; and an adsorption process of separating and recovering the hydrogen by allowing the hydrogen concentrated gas stream to contact an absorbent.

The polymer separation membrane module may selectively separate the hydrogen from a mixed gas containing hydrogen, carbon monoxide, carbon dioxide, nitrogen, methane, and a light hydrocarbon gas.

According to still another aspect of the present invention, a concentration method of hydrogen from a coke oven gas (COG) in a steel industry includes: a pre-processing process of removing impurities including tar, moisture, oil, hydrogen sulfide, and dusts from the coke oven gas (COG); a membrane separation process of generating a hydrogen concentrated gas stream by membrane-separating the coke oven gas (COG) processed in the pre-processing process by using a polymer separation membrane module; and an adsorption process of separating and recovering the hydrogen by allowing the hydrogen concentrated gas stream to contact an absorbent.

The polymer separation membrane module may selectively separate the hydrogen from a mixed gas containing hydrogen, carbon monoxide, carbon dioxide, nitrogen, methane, and a light hydrocarbon gas.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a process flow chart of a separation and recovery system of hydrogen from a coke oven gas COG in a steel industry according to an aspect; and

FIG. 2 is a process flowchart of a membrane separation unit according to an embodiment.

### DETAILED DESCRIPTION

Preferred embodiments of the present invention will be described below in more detail with reference to the accompanying drawings. The present invention may, however, be embodied in different forms and should not be constructed as limited to the embodiments set forth herein. These embodiments are provided so that this disclosure will be thorough and complete, and will fully convey the concept of the present invention to those skilled in the art. In the drawings, the dimensions of layers and regions are exaggerated for clarity. Like reference numerals in the drawings denote like elements Also, portions having similar functions and effects may be expressed with the same or similar reference symbol throughout. Furthermore, when it is described that one comprises (or includes or has) some elements, it should be understood that it may comprise (or include or has) only those elements, or it may comprise (or include or have) other elements as well as those elements if there is no specific limitation.

According to an aspect of the present invention, a separation and recovery system of hydrogen from a coke oven gas (COG) in a steel industry includes: a pre-processing unit configured to remove impurities including tar, moisture, oil, hydrogen sulfide, and dusts from the coke oven gas (COG); a membrane separation unit including a polymer separation membrane module to generate a hydrogen concentrated gas stream by membrane-separating the coke oven gas (COG) processed in the pre-processing unit; and an adsorption unit configured to separate and recover the hydrogen by allowing the hydrogen concentrated gas stream to contact an absorbent.

Hereinafter, a separation and recovery system of hydrogen from a coke oven gas COG in a steel industry according to an aspect will be described in detail with reference to the accompanying drawings.

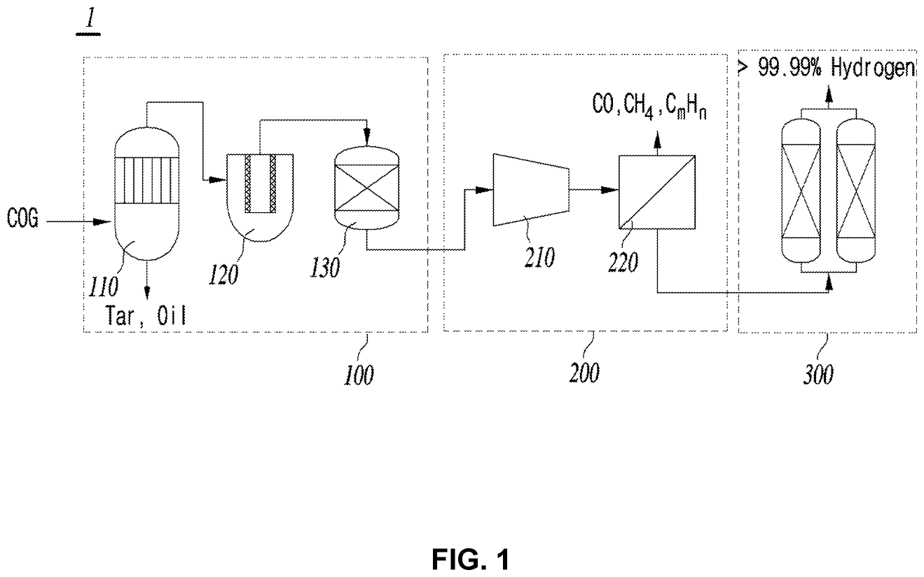

FIG. 1 is a process flow chart of the separation and recovery system of the hydrogen from the coke oven gas COG in the steel industry according to an aspect.

The separation and recovery system of the hydrogen from the coke oven gas COG in the steel industry according to an aspect may separate and recover hydrogen from the coke oven gas COG generated in the steel industry with a high yield of 90% or more and simultaneously recover hydrogen having a high purity of 99% or more, preferably 99.9% or more, and more preferably 99.99% or more.

The system 1 includes a pre-processing unit 100 for removing impurities such as tar, oil, moisture, hydrogen sulfide, and dusts contained in the coke oven gas COG.

The pre-processing unit 100 may include at least one of a condensation device 110, a filtration device 120, and a desulfurization device 130, and preferably include all of the same.

The condensation device 110 is a device for removing moisture, oil, and droplet state tar. To this end, the coke oven gas COG that is a by-product produced from a steel mill may be adjusted in flow rate and then flow into the condensation device 110 of the pre-processing unit 100.

Although the condensation device 110 may be a shell and tube heat exchanger, the present invention is not limited thereto. For example, the condensation device 110 may include various devices for removing moisture, oil, and droplet state tar.

The condensation device 110 may cool the coke oven gas COG by using a refrigerant having a temperature between 0° C. to 20° C. in order to effectively liquefy moisture, oil, and tar and discharge the same downward from the device. A portion of dusts contained in the coke oven gas COG may be also collected by the liquefied impurities and partially removed.

The filtration device 120 may be a device for removing dusts contained in the coke oven gas COG. When the dusts contained in the coke oven gas COG is not removed but introduced to the desulfurization device 130, a membrane separation unit 200 and an adsorption unit 300, an operation may be stopped because devices and pipes are clogged. Thus, when the pre-processing unit 100 includes the filtration device 120 and the desulfurization device 130, the filtration device 120 may be disposed on a front end of the desulfurization device 130.

The filtration device 120 may include a bag filter, a cartridge-type filter, or an electrostatic precipitator to collect and remove remained dusts, i.e., remained particle material, contained in the coke oven gas COG.

The desulfurization device 130 may be a device for removing hydrogen sulfide contained in the coke oven gas COG.

The hydrogen sulfide contained in the coke oven gas COG is produced from coal, i.e., produced when the coal is carbonized to produce coke and remained in the coke oven gas COG. When even a small amount of hydrogen sulfide exists, a lifespan of a fuel cell may decrease, and an efficiency may be degraded. Thus, the hydrogen sulfide is necessary to be completely removed.

The desulfurization device 130 may use all of a wet-type method of absorbing the hydrogen sulfide with a solvent such as amine having a high solubility to remove the hydrogen sulfide or a dry-type method of adsorbing the hydrogen sulfide to an adsorbent to remove the hydrogen sulfide. Preferably, however, the dry-type method having an excellent effect of removing the hydrogen sulfide may be used. Here, an adsorbent of an iron oxide (Fe₂O₃) or a zinc oxide (ZnO) supported on all sorts of support materials such as zeolite, activated carbon, and wood chip may be used.

The desulfurization device 130 may be an adsorption tower in which the adsorbent is disposed, and the hydrogen sulfide contained in the coke oven gas COG may be removed through a repeated cycle process of adsorption and desorption of the adsorption tower.

Also, the system 1 includes the membrane separation unit 200 including a polymer separation membrane module 220 and membrane-separating the coke oven gas COG processed in the pre-processing unit to generate a hydrogen concentrated gas stream.

The membrane separation unit 200 may generate the hydrogen concentrated gas stream from the coke oven gas COG processed in the pre-processing unit 100 to remove tar, moisture, oil, hydrogen sulfide, and dusts therefrom and preferably generate the hydrogen concentrated gas stream containing hydrogen at about 95 vol % or more of an entire volume thereof from the coke oven gas COG containing hydrogen at 50 vol % to 60 vol % or more of an entire volume thereof.

The membrane separation unit 200 may be a device including the polymer separation membrane module 220 to concentrate hydrogen in a membrane separation method for separating hydrogen by a pressure difference between a remaining side and a transmission side of the polymer separation membrane module 210.

The polymer separation membrane module 220 may include a polymer separation membrane for separating hydrogen from the coke oven gas COG processed in the pre-processing unit.

The polymer separation membrane module 220 may include a polymer separation membrane for selectively allowing hydrogen to be transmitted or remained from a mixed gas containing carbon monoxide, carbon dioxide, nitrogen, methane, and light hydrocarbon gases, and preferably include a polymer separation membrane for selectively allowing hydrogen to be transmitted in consideration of usage easiness and effectiveness of hydrogen separation.

Here, the light hydrocarbon may be hydrocarbon of C2 or more, and preferably C2 to C4.

Thus, the polymer separation membrane, as a separation membrane having an excellent selectivity to hydrogen, may include one kind or more selected from the group consisting of polysulfone, polyimide, and polybenzimidazole.

The polysulfone, polyimide, and polybenzimidazole-based polymer separation membrane may have a hydrogen selectivity to carbon monoxide, nitrogen, methane, and light hydrocarbon except for carbon dioxide, which is 20 or more, preferably 20 to 200, to effectively transmit and separate hydrogen by separately remove carbon monoxide, nitrogen, methane, and light hydrocarbon from the coke oven gas COG except for carbon dioxide.

Also, the polysulfone, polyimide, and polybenzimidazole-based polymer separation membrane, as a glassy polymer membrane, may increase the selectivity because a dispersion coefficient of hydrogen having a small molecular size increases while a solubility of CO₂ decreases as a temperature increases.

Thus, as the polysulfone, polyimide, and polybenzimidazole-based polymer separation membrane is used in the membrane separation unit 200, and the temperature of the gas stream transferred to the polymer separation module 220 is maintained preferably in a range from 0° C. to 100° C., more preferably in a range from 20° C. to 50° C., the selectivity of hydrogen to carbon dioxide may further increase, and by this method, the hydrogen may be further effectively transmitted and separated.

The polymer separation module 220 may have a hollow fiber type shape, a spiral wound type shape, or a flat type shape. However, the present invention is not limited thereto. For example, the polymer separation module 220 may have a different shape.

The polymer separation module 220 may have a hydrogen transmittance of 50 GPU to 500 GPU, preferably 50 GPU or more. When the polymer separation module 220 has a hydrogen transmittance less than 50 GPU, an area of the membrane necessary for recovering hydrogen with a high recovery rate may increase, and thus an economical efficiency may be remarkably degraded.

Also, the polymer separation membrane may have a hydrogen selectivity to carbon monoxide, methane, and nitrogen in a range from 10 to 200, preferably in a range from 20 to 100. When the hydrogen selectivity to carbon monoxide, methane, and nitrogen is less than 10, more compressors may be required to recover hydrogen having a high concentration, and also a flow rate of a gas recirculated to the compressor may increase to increase a cost for compressing the gas, thereby causing economical cost increase. Also, when the hydrogen selectivity to carbon monoxide, methane, and nitrogen is greater than 200, as a hydrogen concentration of a transmission side from a gas inlet of the membrane reaches 100%, and the pressure difference is not generated, a separation driving power may be weakened to require a huge area of the membrane, and thus an economical efficiency may be remarkably degraded

The polymer separation membrane may have a hydrogen selectivity to carbon dioxide in a range from 2 to 13.

Also, the membrane separation unit 200 may further include a compressor 210 disposed on a front end of the polymer separation module 220.

The compressor 210 may increase a pressure of the gas stream introduced to the polymer separation membrane module 220, i.e., a pressure of the remaining side, to increase a membrane separation efficiency.

The compressor 210 may compress the gas stream to a pressure of 5 bar to 15 bar based on an absolute pressure, more preferably a pressure of 8 bar to 12 bar. Through this, the pressure of the gas stream introduced to the polymer separation membrane module 220, i.e., the pressure of the remaining side, may be in a range from 5 bar to 15 bar based on the absolute pressure, more preferably in a range from 8 bar to 12 bar, and the pressure of the gas stream transmitted through the polymer separation membrane module 220, i.e., the pressure of the transmission side, may be in an atmosphere or vacuum state of 0.001 bar to 1.2 bar.

Also, the membrane separation unit 200 may further include a cooler disposed on a front end of the polymer separation membrane module 220, and preferably disposed in the compressor 210 or on a rear end of the compressor 210.

The cooler may maintain a temperature of the gas stream introduced to the polymer separation membrane module 220, i.e., a temperature of the remaining side, in a range from 0° C. to 100° C. to prevent the polymer separation membrane module 220 from being damaged and increase the membrane separation efficiency.

That is, as heat is generated in an operation and compression process of the compressor, the temperature of the gas stream compressed by the compressor 210 may increase. Thus, as the cooler is disposed in the compressor 210 or on the rear end of the compressor 210, the gas stream introduced to the polymer separation membrane module 220, i.e., the gas stream at the remaining side, may maintain a temperature in a range from 0° C. to 100° C.

When the gas stream transferred to the polymer separation membrane module 220 has a temperature less than 0° C., the separation membrane may be damaged due to moisture freeze in the polymer separation membrane, and when the temperature is greater than 100° C., the separation membrane may be damaged by deterioration thereof.

The gas stream in which the hydrogen produced by the membrane separation unit 200 is concentrated may have a concentration of 95% and a recovery rate of 95% or more.

This is for recovering hydrogen having a high purity of 99% or more, preferably 99.9% or more, and more preferably 99.99% or more, with a high recovery rate even through the less number of adsorption process in the adsorption unit, preferably 4-bed or less adsorption process, more preferably 2-bed adsorption process, and further more preferably 1-bed adsorption process.

When the hydrogen recovery rate of the gas stream in which the hydrogen is concentrated is less than 95%, a final recovery rate may be less than 90% because of a gas loss amount that is lost in a process of desorbing the gas adsorbed in the adsorption unit 300 that is performed after the membrane separation unit 200. Also, when the hydrogen concentration of the gas stream in which the hydrogen is concentrated is less than 95%, a more complicate adsorption process may be required to produce the hydrogen having a high purity of 99% or more, and thus the economical efficiency may be degraded.

To this end, the membrane separation unit 200 may have a multistage separation membrane package shape which includes a plurality of separation membrane packages each including at least one polymer separation membrane module and in which at least two of the plurality of separation membrane packages are connected in serial.

Here, the separation membrane package 221 represents a bundle of separation membrane modules including the plurality of polymer separation membrane modules 220 and more preferably represent a bundle of separation membrane modules in which the plurality of polymer separation membrane modules are connected in parallel.

Also, the membrane separation unit 200 may have a circulation structure of re-supplying the gas stream discharged from an outlet of the remaining side of the separation membrane package disposed on a rear end of the separation membrane packages to an inlet of the remaining side of the separation membrane package disposed on a frontmost end of the separation membrane packages.

The separation and recovery system of the hydrogen from the coke oven gas COG in the steel industry according to an aspect may increase the purity and the recovery rate of the hydrogen that is separated and recovered from the coke oven gas COG to 95% or more through the multistage separation membrane package of the membrane separation unit 200.

Although the separation membrane package may have a two-stage separation membrane package structure in which two separation membrane packages are connected in serial, the present invention is not limited thereto. For example, the separation membrane package may have various structures in which two or more separation membrane packages are connected in serial and/or in parallel.

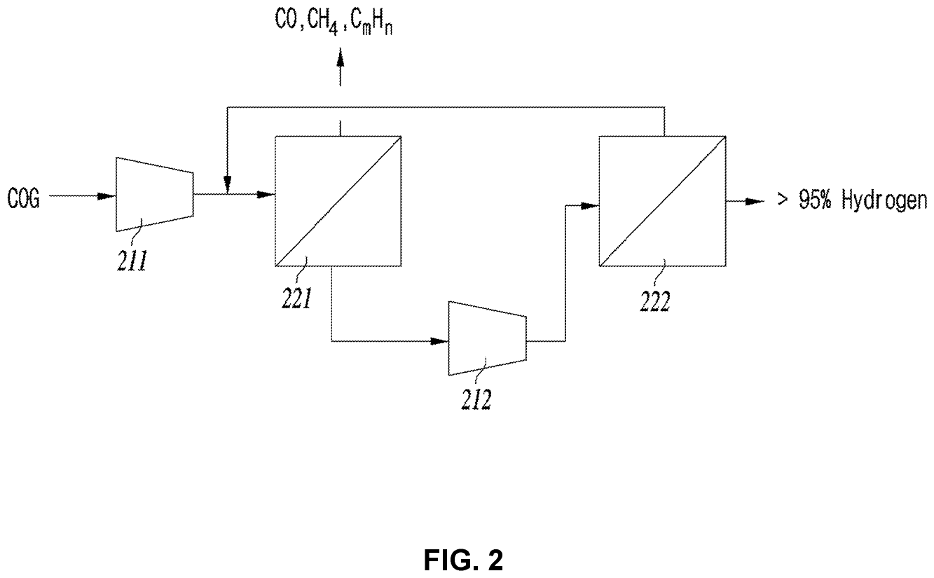

FIG. 2 is a process flowchart of the membrane separation unit including two-stage separation membrane package including two compressors and two separation membrane packages.

Referring to FIG. 2, the membrane separation unit 200 may include the two-stage separation membrane package in which an outlet of a first compressor 211 is connected with an inlet of a first separation membrane package 221, a transmission side outlet of the first separation membrane package 221 is connected with an inlet of a second compressor 212, an outlet of the second compressor 212 is connected with a remaining side inlet of a second separation membrane package 222, and a remaining side outlet of the second separation membrane package 222 is connected to a pipe between the outlet of the first compressor 211 and the remaining side inlet of the first separation membrane package 221.

A process of the membrane separation unit using the two-stage separation membrane package will be performed in a method below.

Firstly, the coke oven gas COG from which tar, oil, moisture, hydrogen sulfide, and dusts are removed in the pre-processing unit 100 may be compressed at a pressure of 5 bar to 15 bar by the first compressor 211 of the membrane separation unit 200 and then introduced to the remaining side inlet of the first separation membrane package 221.

Among constituents of the gas stream introduced to the first separation membrane package 221, hydrogen and a portion of carbon dioxide may be transmitted to the transmission side by the polymer separation membrane module having a high selectivity of the hydrogen contained in the first separation membrane package, and carbon monoxide, nitrogen, methane, and light hydrocarbon gases may be discharged to the outside through the remaining side outlet.

Thereafter, the gas stream separately discharged to the transmission side of the first separation membrane package 221 may be compressed at a pressure of 5 bar to 15 bar by the second compressor 212 and then introduced to the second separation membrane package 222.

Gas constituents that are not transmitted among the constituents of the gas stream introduced to the second separation membrane package 222 may be discharged to the remaining side outlet and re-supplied to the first separation membrane package 221, and the gas stream discharged to the transmission side of the second separation membrane package 222 may be supplied to the adsorption unit 300.

Here, as the gas of the remaining side of the second separation membrane package is re-supplied to the second separation membrane package, the recovery rate of the hydrogen recovered in the membrane separation unit 200 may increase to 95% or more.

Also, in order to increase the hydrogen selectivity of the first separation membrane package 221 and the second separation membrane package 222, the polymer separation membrane module 220 contained in each of the first separation membrane package 221 and the second separation membrane package 222 may include a polymer separation membrane made of at least one kind selected from the group consisting of polysulfone, polyimide, and polybenzimidazole, which have a high hydrogen selectivity.

Also, the polysulfone, polyimide, and polybenzimidazole-based separation membrane, as a glassy polymer membrane, exhibits an effect of increasing the selectivity as a dispersion coefficient of the hydrogen having a small molecular size increases while a solubility of CO₂ decreases as a temperature increases. Thus, in order to increase the hydrogen selectivity and simultaneously decrease the carbon dioxide selectivity of the polymer separation membrane, the gas stream introduced to the first separation membrane package 221 and the second separation membrane package 222 may be maintained preferably at a temperature of 0° C. to 100° C., and more preferably at a temperature of 20° C. to 50° C.

Also, the system 1 includes the adsorption unit 300 for separating and recovering hydrogen by allowing the adsorbent to contact the gas stream in which hydrogen is concentrated.

The adsorption unit 300 may be a device for removing carbon dioxide that is not removed in the membrane separation unit 200, and a small amount of carbon monoxide, nitrogen, methane, and light hydrocarbon to separate and recover the hydrogen having a high purity of 99% or more, preferably 99.9% or more, and more preferably 99.99% or more.

The adsorption unit 300 may be performed in a pressure swing adsorption (PSA) method using an adsorption tower in which one kind of adsorbent or one or more kinds of adsorbents are filled in a single layer or multiple layers.

Since the system 1 transfers the gas stream containing an impurity gas less than 5% except for hydrogen to the adsorption unit 300, the adsorption unit 300 may improve an energy economical efficiency in comparison with a typical pressure swing adsorption (PSA) process because the adsorption unit 300 is performed preferably in the pressure swing adsorption (PSA) method using 4-beds or less, and more preferably in the pressure swing adsorption (PSA) method using 2-beds or less.

Also, since the impurity gas transferred to the adsorption unit 300 except for hydrogen is extremely low less than 5%, the adsorbent used to remove the impurity gas may be used longer than that used in the typical pressure swing adsorption (PSA) process.

The separation and recovery system 1 of the hydrogen from the coke oven gas COG in a steel industry according to an aspect may recover the hydrogen having a high purity of 99% or more, preferably 99.9% or more, and more preferably 99.99% or more with a high recovery rate by separating the hydrogen having a high concentration of 95% or more with a recovery rate of 95% or more from the coke oven gas COG using the membrane separation method in the membrane separation unit 200 and then removing the unremoved impurity gas less than 5% in the adsorption unit 300.

Also, the system 1 may recover the hydrogen having the high purity from the coke oven gas COG with the high economical efficiency by minimizing the adsorption process that requires high capital costs and energy expenses to reduce a unit price of hydrogen recovery.

According to another aspect of the present invention, a separation and recovery method of hydrogen from a coke oven gas (COG) in a steel industry includes: a pre-processing process of removing impurities including tar, moisture, oil, hydrogen sulfide, and dusts from the coke oven gas (COG); a membrane separation process of generating a hydrogen concentrated gas stream by membrane-separating the coke oven gas (COG) processed in the pre-processing process by using a polymer separation membrane module; and an adsorption process of separating and recovering the hydrogen by allowing the hydrogen concentrated gas stream to contact an absorbent.

The separation and recovery method of the hydrogen from the coke oven gas COG in the steel industry may be performed by using the separation and recovery system of the hydrogen from the coke oven gas COG in the steel industry and thus may include a portion or a whole of the above-described features of the separation and recovery system of the hydrogen from the coke oven gas COG in the steel industry.

Hereinafter, a separation and recovery method of hydrogen from a coke oven gas (COG) in a steel industry according to another aspect will be specifically described in each process.

Firstly, the separation and recovery method of the hydrogen from the coke oven gas (COG) in the steel industry according to another aspect includes a pre-processing process of removing tar, moisture, oil, hydrogen sulfide, and dusts from the coke oven gas COG.

The pre-processing process, as a process of removing tar, moisture, oil, hydrogen sulfide, and dusts contained in the coke oven gas COG, may be performed by using at least one of a condensation device, a filtration device, and a desulfurization device, and preferably performed by using all of the same.

More particularly, the pre-processing process may include: a condensing process of condensing and removing moisture, oil, and droplet state tar by cooling the coke oven gas COG using the condensation device; a filtering process of removing dusts contained in the coke oven gas COG by using the filtration device; and a desulfurizing process of removing hydrogen sulfide contained in the coke oven gas COG by using the desulfurization device.

Here, the condensation device 110 may cool the coke oven gas COG by using a refrigerant having a temperature between 0° C. to 20° C. in order to effectively liquefy moisture, oil, and tar and discharge the same downward from the device. A portion of dusts contained in the coke oven gas COG may be also collected by the liquefied impurities and partially removed.

Also, the filtration device 120 may include a bag filter, a cartridge-type filter, or an electrostatic precipitator to collect and remove remained dusts, i.e., remained particle material, contained in the coke oven gas COG.

Also, the desulfurization device 130 may use all of a wet-type method of absorbing the hydrogen sulfide with a solvent such as amine having a high solubility to remove the hydrogen sulfide or a dry-type method of adsorbing the hydrogen sulfide to an adsorbent to remove the hydrogen sulfide. Preferably, however, the dry-type method having an excellent effect of removing the hydrogen sulfide may be used. Here, an adsorbent of an iron oxide (Fe₂O₃) or a zinc oxide (ZnO) supported on all sorts of support materials such as zeolite, activated carbon, and wood chip may be used. Also, the desulfurization device 140 may be an adsorption tower in which the adsorbent is disposed, and the hydrogen sulfide contained in the coke oven gas COG may be removed through a repeated cycle process of adsorption and desorption of the adsorption tower.

Thereafter, the separation and recovery method of the hydrogen from the coke oven gas (COG) in the steel industry according to another aspect includes a membrane separation process of membrane-separating the coke oven gas COG processed in the pre-processing process to generate a gas stream in which the hydrogen is concentrated.

The membrane separation process, as a process of generating the hydrogen concentrated gas stream from the coke oven gas COG processed in the pre-processing unit 100 to remove tar, moisture, oil, hydrogen sulfide, and dusts therefrom, may preferably generate the hydrogen concentrated gas stream containing hydrogen at about 95 vol % or more of an entire volume thereof from the coke oven gas COG containing hydrogen at 50 vol % to 60 vol % or more of an entire volume thereof.

The membrane separation process may be a process of separating the hydrogen by a pressure difference between a remaining side and a transmission side of a polymer separation membrane module.

Here, the polymer separation membrane module may include a polymer separation membrane for selectively allowing hydrogen to be transmitted or remained from a mixed gas containing carbon monoxide, carbon dioxide, nitrogen, methane, and light hydrocarbon gases, and preferably include a polymer separation membrane for selectively allowing hydrogen to be transmitted in consideration of usage easiness and effectiveness of hydrogen separation.

Thus, the polymer separation membrane, as a separation membrane having an excellent selectivity to hydrogen and used in the membrane separation process, may include one kind or more selected from the group consisting of polysulfone, polyimide, and polybenzimidazole.

The polysulfone, polyimide, and polybenzimidazole-based polymer separation membrane may have a hydrogen selectivity to carbon monoxide, nitrogen, methane, and light hydrocarbon except for carbon dioxide, which is 20 or more, and preferably 20 to 200, to effectively transmit and separate hydrogen by separately remove carbon monoxide, nitrogen, methane, and light hydrocarbon from the coke oven gas COG except for carbon dioxide.

Thus, the membrane separation process may use the polymer separation membrane made of one kind or more selected from the group consisting of polysulfone, polyimide, and polybenzimidazole and maintain a temperature of the gas stream transferred to the polymer preferably in a range from 0° C. to 100° C., and more preferably in a range from 20° C. to 50° C., to further increase the hydrogen selectivity, thereby further increasing the separation of recovery efficiency of the hydrogen.

Also, the membrane separation process may increase a pressure of the gas stream introduced to the polymer separation membrane, i.e., a pressure of the remaining side, to increase the membrane separation efficiency.

To this end, the compressor may be disposed on a front end of the polymer separation membrane module, and the gas stream introduced to the polymer separation membrane module may be compressed by the compressor at a pressure of 5 bar to 15 bar based on an absolute pressure, and more preferably at a pressure of 8 bar to 12 bar.

Also, the compressor may maintain a temperature of the gas stream introduced to the polymer separation membrane module 220, i.e., a temperature of the remaining side, in a range from 0° C. to 100° C. to prevent the polymer separation membrane module 220 from being damaged and increase the membrane separation efficiency.

To this end, a cooler may be disposed at a front end of the polymer separation membrane module, and more preferably, disposed in the compressor or at a rear end of the compressor.

The gas stream in which the hydrogen produced in the membrane separation process is concentrated may have a concentration of 95% and a recovery rate of 95% or more.

This is for recovering hydrogen having a high purity of 99% or more, preferably 99.9% or more, and more preferably 99.99% or more, with a high recovery rate even through the less number of adsorption process in a following adsorption process, preferably 4-bed or less adsorption process, and more preferably 2-bed adsorption process.

When the hydrogen recovery rate of the gas stream in which the hydrogen is concentrated is less than 95%, a final recovery rate may be less than 90% because of a gas loss amount that is lost in a process of desorbing the gas adsorbed in the adsorption process that is performed after the membrane separation process. Also, when the hydrogen concentration of the gas stream in which the hydrogen is concentrated is less than 95%, a more complicate adsorption process may be required to produce the hydrogen having a high purity of 99% or more, and thus the economical efficiency may be degraded.

To this end, the membrane separation process may be performed by using a multistage separation membrane package shape which includes a plurality of separation membrane packages each including at least one polymer separation membrane module and in which at least two of the plurality of separation membrane packages are connected in serial.

Also, the membrane separation package may have a circulation structure of re-supplying the gas stream discharged from an outlet of the remaining side of the separation membrane package disposed on a rear end of the separation membrane packages to an inlet of the remaining side of the separation membrane package disposed on a frontmost end of the separation membrane packages.

The separation and recovery method of the hydrogen from the coke oven gas COG in the steel industry according to another aspect may increase the purity and the recovery rate of the hydrogen that is separated and recovered from the coke oven gas COG to 95% or more by using the multistage separation membrane package in the membrane separation process.

Although the separation membrane package may have a two-stage separation membrane package structure in which two separation membrane packages are connected in serial, the present invention is not limited thereto. For example, the separation membrane package may have various structures in which two or more separation membrane packages are connected in serial and/or in parallel.

FIG. 2 is a process flowchart of the membrane separation process performed by using the two-stage separation membrane package. Referring to FIG. 2, the two-stage separation membrane package may have a structure in which an outlet of a first compressor 211 is connected with an inlet of a first separation membrane package 221, a transmission side outlet of the first separation membrane package 221 is connected with an inlet of a second compressor 212, an outlet of the second compressor 212 is connected with a remaining side inlet of a second separation membrane package 222, and a remaining side outlet of the second separation membrane package 222 is connected to a pipe between the outlet of the first compressor 211 and the remaining side inlet of the first separation membrane package 221.

A process of the membrane separation process using the two-stage separation membrane package will be performed in a method below.

Firstly, the pre-processed coke oven gas COG may be compressed at a pressure of 5 bar to 15 bar by the first compressor 211 and then introduced to the remaining side inlet of the first separation membrane package 221.

Thereafter, among constituents of the gas stream introduced to the first separation membrane package 221, hydrogen and a portion of carbon dioxide may be transmitted to the transmission side by the polymer separation membrane module having a high selectivity of the hydrogen contained in the first separation membrane package, and carbon monoxide, nitrogen, methane, and light hydrocarbon gases may be discharged to the outside through the remaining side outlet.

Thereafter, the gas stream separately discharged to the transmission side of the first separation membrane package 221 may be compressed at a pressure of 5 bar to 15 bar by the second compressor 212 and then introduced to the second separation membrane package 222.

Gas constituents that are not transmitted among the constituents of the gas stream introduced to the second separation membrane package 222 may be discharged to the remaining side outlet and re-supplied to the first separation membrane package 221, and the gas stream discharged to the transmission side of the second separation membrane package 222 may be supplied to the adsorption unit 300.

Here, as the gas of the remaining side of the second separation membrane package is re-supplied to the second separation membrane package, the recovery rate of the hydrogen recovered in the membrane separation unit 200 may increase to 95% or more.

Next, the separation and recovery method of the hydrogen from the coke oven gas COG in the steel industry according to another aspect include an adsorption process of separating and purifying the hydrogen by allowing the gas stream in which the hydrogen is concentrated to contact the adsorbent.

The adsorption process may be a process for removing carbon dioxide that is not removed in the membrane separation process, and a small amount of carbon monoxide, nitrogen, methane, and light hydrocarbon to separate and recover the hydrogen having a high purity of 99% or more, preferably 99.9% or more, and more preferably 99.99% or more.

The adsorption process may be performed in a pressure swing adsorption (PSA) method using an adsorption tower in which one kind of adsorbent or one or more kinds of adsorbents are filled in a single layer or multiple layers. Since the gas stream transferred to the adsorption process contains an impurity gas less than 5% except for the hydrogen, the adsorption process may improve an energy economical efficiency in comparison with a typical pressure swing adsorption (PSA) process because the adsorption process is performed preferably in the pressure swing adsorption (PSA) method using 4-beds or less, and more preferably in the pressure swing adsorption (PSA) method using 2-beds or less and use the adsorbent longer in comparison with that used in the typical pressure swing adsorption (PSA) method.

According to still another aspect of the present invention, a concentration method of hydrogen from a coke oven gas (COG) in a steel industry includes: a pre-processing process of removing impurities including tar, moisture, oil, hydrogen sulfide, and dusts from the coke oven gas (COG); a membrane separation process of generating a hydrogen concentrated gas stream by membrane-separating the coke oven gas (COG) processed in the pre-processing process by using a polymer separation membrane module; and an adsorption process of separating and recovering the hydrogen by allowing the hydrogen concentrated gas stream to contact an absorbent.

The concentration method of the hydrogen from the coke oven gas COG in the steel industry may include a portion or a whole of the above-described features of the separation and recovery method of the hydrogen from the coke oven gas COG in the steel industry.

Since the concentration method of the hydrogen may concentrate the hydrogen at a concentration of 95% or more through a membrane separation process, the concentration method of the hydrogen may concentrate the hydrogen at a concentration of 99% or more, preferably 99.9% or more, and more preferably 99.99% or more from the coke oven gas COG by using only the pressure swing adsorption (PSA) method using 4-beds or less, and preferably 2-beds or less in a following adsorption process.

Hereinafter, the present invention will be described in more detail according to an embodiment. However, the scope of the present invention is not limited to the embodiments below.

### Embodiment 1

Process 1: a pre-processing device in which a condensation device, a filtration device, and a desulfurization device are sequentially connected to remove tar, oil, moisture, hydrogen sulfide, and dusts by pre-processing a coke oven gas COG that is a by-produced from a steel mill with a composition of table 1 below is manufactured and installed and pre-processes the coke oven gas COG while supplying the coke oven gas COG at a flow rate of 1.1 Nm³/hr.

TABLE 1

| Composition (vol %) | | | | | | Heating value |
|---|---|---|---|---|---|---|
| H₂ | CO | CO₂ | CH₄ | CₘHₙ | N₂ | (Kcal/Nm³) |
| 56.4 | 8.4 | 3.1 | 26.6 | 2.0 | 2.3 | 4,400 |

CₘHₙ: hydrocarbon of C₂ or more

Here, the shell and tube condensation device is manufactured by installing four 1-inch stainless 304 pipes having a schedule number of 10 and a length of 60 as inner pipes and filling metal fillers made of a stainless material into the inner pipes in order to accelerate a liquefied speed of impurities and heat transfer in the pipes. As the filtration device, a bag filter type commercial product made of a polyester material and having a diameter of 30 cm and a length of 80 cm is bought to be used. Also, as the desulfurization device for removing about 1000 ppm of the hydrogen sulfide contained in the coke oven gas COG, an adsorption tower is manufactured by using 8-inch stainless 316 pipes having a schedule number of 10 and a length of 100 cm and installed by filling an adsorbent supported on an oxide thereto. As a result of analyzing the coke oven gas COG transmitted through the pre-processing unit, it is shown that each of tar, oil, and hydrogen sulfide has a concentration of 0.5 ppm or less.

Process 2: a membrane separation-adsorption mixed process device including the membrane separation unit having two-stage separation membrane package and the adsorption unit having a 1-bed adsorption tower is manufactured and installed, and recovers the hydrogen while supplying the coke oven gas COG pre-processed in the process 1 at a flow rate of 1 Nm³/hr.

Here, each of the first compressor 211 and the second compressor 212 used in the two-stage separation membrane package is a diaphragm type compressor capable of compressing the coke oven gas COG with a maximum pressure of 15 bar and a flow rate of 3 Nm³/hr. Also, two to four hollow fiber type polysulfone membrane modules each having a unit membrane area of 0.1 m2 and 1 m2 are installed in parallel as the polymer separation membrane, so that the first separation membrane package 221 has a membrane area of 2.2 m2, and the second separation membrane package 222 has a membrane area of 0.14 m2. A gas transmittance of the polysulfone membrane is stated in table 2 below.

The remaining side pressure of each of the first and second separation membrane packages is 10 bar based on the absolute pressure, the transmission side pressure is 1 bar that is the atmospheric pressure, and the temperature of each of the first and second separation membrane packages is maintained at a temperature of 25° C.

TABLE 2

| Separation | Transmittance | | | | | |
|---|---|---|---|---|---|---|
| membrane | H₂ | CO | CO₂ | CH₄ | CₘHₙ | N₂ |
| Polysulfone | 173.7 | 5.3 | 78.3 | 3.2 | 4.0 | 2.9 |
| Polyimide | 500.0 | 8.9 | 151.5 | 6.0 | 5.0 | 1.3 |
| Cross-linked | 55.9 | 0.06 | 3.49 | 0.055 | 0.058 | 0.03 |
| polybenzimidazole | | | | | | |

Also, the adsorption tower of the adsorption unit 300 is manufactured with a double pipe structure made of stainless 316 steel to remove generated heat by using a refrigerant. An inner pipe in which the absorbent is filled has an inner diameter of 8 inches and a length of 100 cm. As the adsorbent, zeolite 13X with a height of 50 cm and silica gel with a height of 30 cm are filled in the inner pipe, and a gas adsorption is performed at a pressure of 7 bar.

### Embodiment 2

The same process as the embodiment 1 is performed except that two to eight hollow fiber type polyimide membrane modules made of diphenyl tetracarboxylicdianhidride and diaminodiphenyl ether and each having a unit membrane area of 0.1 m2 are installed in parallel as the polymer separation membrane, so that the first separation membrane package has a membrane area of 0.5 m2, and the second separation membrane package has a membrane area of 0.05 m2, and activated carbon with a height of 50 cm and alumina with a height of 30 cm are filled in a 1-bed adsorption tower as the adsorbent.

### Embodiment 3

The same process as the embodiment 1 is performed except that two to eight flat membrane type separation membrane modules made of polybenzimidazoles crosslinked by dibromo-p-xylene and each having a unit membrane area of 0.1 m2 are installed in parallel as the polymer separation membrane, so that the first separation membrane package has a membrane area of 0.5 m2, and the second separation membrane package has a membrane area of 0.5 m2, and a carbon molecular sieve with a height of 50 cm and alumina with a height of 30 cm are filled in a 1-bed adsorption tower as the adsorbent.

### Experimental Example 1

The gas constituents and concentrations of the remaining side gas (membrane discharged gas) of the first separation membrane, the transmission side gas (separation membrane concentrated hydrogen) transmitted through the second separation membrane, and the gas (adsorption tower recover gas) finally recovered after the adsorption process in the membrane separation process of the embodiments 1 to 3 are analyzed by gas chromatography, and the results are shown in tables 3 to 5 below.

TABLE 3

| | Flow | | | | | | | |
|---|---|---|---|---|---|---|---|---|
| | rate | Recovery | Concentration (%) | | | | | |
| Gas | (Nm³/hr) | rate (%) | H₂ | CO | CO₂ | N₂ | CH₄ | CₘHₙ |
| Separation | 0.56 | 95.51 | 96.96 | 0.024 | 2.968 | 0.002 | 0.042 | 0.002 |
| membrane | | | | | | | | |
| concentrated | | | | | | | | |
| hydrogen | | | | | | | | |
| Separation | 0.44 | — | 5.69 | 18.87 | 3.26 | 5.17 | 59.80 | 4.95 |
| membrane | | | | | | | | |
| discharged | | | | | | | | |
| gas | | | | | | | | |
| Adsorption | 0.51 | 90.25 | 99.99 | <1 ppm | <1 ppm | <1 ppm | <1 ppm | <1 ppm |
| tower | | | | | | | | |
| recovery gas | | | | | | | | |

The above table 3 shows a result of the embodiment 1. As shown in the table 3, it may be known that as hydrogen is concentrated with a concentration of 96.96% and a recovery rate of 95.51% through a polysulfone two-state membrane separation process, concentrated hydrogen is introduced to the adsorption process at a flow rate of 0.56 Nm³/hr, a gas recovered finally after the adsorption process has a hydrogen concentration of 99.99% or more and includes carbon monoxide, carbon dioxide, nitrogen, methane, and a light hydrocarbon gas, each of which has a concentration less than 1 ppm, and the finally recovered gas has a hydrogen recovery rate of 90.25%.

Also, it is shown that impurities contained in the concentrated hydrogen to flow into the adsorption process has a total flow rate of 0.017 Nm³/hr that corresponds to about 1/26 of a total flow rate of 0.436 Nm³/hr of impurities contained in the coke oven gas COG supplied at a flow rate of 1 Nm³/hr to recover the hydrogen.

This is a method of separating and recovering the hydrogen from the coke oven gas COG, representing that a size of the pressure swing adsorption (PSA) process may be reduced into 1/26 by selectively performing the membrane separation in comparison with a case of using only the pressure swing adsorption (PSA) process. That is, this method represents that the high purity hydrogen may be recovered with a further high economical efficiency.

TABLE 4

| | Flow | | | | | | | |
|---|---|---|---|---|---|---|---|---|
| | rate | Recovery | Concentration (%) | | | | | |
| Gas | (Nm³/hr) | rate (%) | H₂ | CO | CO₂ | N₂ | CH₄ | CₘHₙ |
| Separation | 0.56 | 96.36 | 97.60 | 0.022 | 2.354 | 0.004 | 0.022 | 0.000 |
| membrane | | | | | | | | |
| concentrated | | | | | | | | |
| hydrogen | | | | | | | | |
| Separation | 0.44 | — | 4.63 | 18.93 | 4.04 | 5.19 | 59.99 | 4.96 |
| membrane | | | | | | | | |
| discharged gas | | | | | | | | |
| Adsorption tower | 0.52 | 91.54 | 99.99 | <1 ppm | <1 ppm | <1 ppm | <1 ppm | <1 ppm |
| recovery gas | | | | | | | | |

The above table 4 shows a result of the embodiment 2. As shown in the table 4, it may be known that as the embodiment 2 uses a polyimide membrane having a transmittance much greater than the polysulfone membrane used in the embodiment 1, so that hydrogen is concentrated with a concentration of 96.36% and a recovery rate of 97.60% through the two-stage membrane separation process although a membrane area that is smaller by four times than that of the embodiment 1, as concentrated hydrogen is introduced to the adsorption process at a flow rate of 0.56 Nm³/hr, a gas recovered finally after the adsorption process has a hydrogen concentration of 99.99% or more and includes carbon monoxide, carbon dioxide, nitrogen, methane, and a light hydrocarbon gas, each of which has a concentration less than 1 ppm, and the finally recovered gas has a flow rate of 0.52 Nm³/hr and a hydrogen recovery rate of 91.54%.

TABLE 5

| | Flow rate | Recovery | Concentration (%) | | | | | |
|---|---|---|---|---|---|---|---|---|
| Gas | (Nm³/hr) | rate (%) | H₂ | CO | CO₂ | N₂ | CH₄ | CₘHₙ |
| Separation | 0.55 | 95.94 | 98.87 | 0.002 | 1.153 | 0.000 | 0.005 | 0.000 |
| membrane | | | | | | | | |
| concentrated | | | | | | | | |
| hydrogen | | | | | | | | |
| Separation | 0.45 | — | 5.06 | 18.56 | 5.45 | 5.08 | 58.77 | 4.86 |
| membrane | | | | | | | | |
| discharged | | | | | | | | |
| gas | | | | | | | | |
| Adsorption | 0.52 | 92.10 | 99.99 | <1 ppm | <1 ppm | <1 ppm | <1 ppm | <1 ppm |
| tower | | | | | | | | |
| recovery gas | | | | | | | | |

The above table 5 shows a result of the embodiment 3. As shown in the table 5, it may be known that hydrogen is concentrated with a concentration of 95.94% and a recovery rate of 98.84% through the two-stage membrane separation process by using a flat membrane type separation membrane made of polybenzimidazoles crosslinked by dibromo-p-xylene, and as about 0.16% of impurities are removed in the adsorption process, the gas finally recovered after the adsorption process has a hydrogen concentration of 99.99% and a hydrogen recovery rate of 92.1%.

Through the above experimental results, the separation and recovery method of the hydrogen from the coke oven gas (COG) in the steel industry may separate and recover the hydrogen from the coke oven gas COG in the membrane separation-adsorption mixed process to recover the hydrogen having the high purity of 99.99% or more by using the adsorption tower having a small size of 1/68 of that of a case when recovering the hydrogen by using only the pressure swing adsorption method, thereby exhibiting the excellent energy economical efficiency.

The separation and recovery system and method of the hydrogen from the coke oven gas (COG) in the steel industry according to the present invention may recover the hydrogen having the purity of 99.99% or more with the high recovery rate of 90% or more, which is usable as the chemical raw material and the fuel of the value-added fuel cell, from the coke oven gas (COG) with the low energy costs.

Thus, the large amount of hydrogen having the high purity may be produced by using the coke oven gas (COG), which is by-produced at least one hundred million tons annually in the world and about four to five hundred thousand tons even in this country, and used as the fuel for the fuel cell and the raw material in the chemical industry.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. A separation and recovery system of hydrogen from a coke oven gas (COG) in a steel industry, comprising:
a pre-processing unit configured to remove impurities comprising tar, moisture, oil, hydrogen sulfide, and dusts from the coke oven gas (COG);
a membrane separation unit comprising a polymer separation membrane module to generate a hydrogen concentrated gas stream by membrane-separating the coke oven gas (COG) processed in the pre-processing unit; and
an adsorption unit configured to separate and recover the hydrogen by allowing the hydrogen concentrated gas stream to contact an absorbent.

2. The separation and recovery system of claim 1, wherein the membrane separation unit comprises a plurality of separation membrane packages each comprising at least one polymer separation membrane module,
wherein at least two separation membrane packages of the plurality of separation membrane packages are connected in serial.

3. The separation and recovery system of claim 2, wherein the membrane separation unit has a circulation structure of re-supplying a gas stream discharged from a remaining side outlet of the separation membrane package disposed on a rear end of the separation membrane packages to a remaining side inlet of the separation membrane package disposed on a front most end of the separation membrane packages.

4. The separation and recovery system of claim 2, wherein the separation membrane package further comprises a compressor disposed on a front end of each of the separation membrane packages.

5. The separation and recovery system of claim 4, wherein the compressor compresses the gas stream transferred to the separation membrane package at a pressure of 5 bar to 15 bar.

6. The separation and recovery system of claim 1, wherein the polymer separation membrane module comprises a polymer separation membrane configured to selectively separate the hydrogen from a mixed gas containing hydrogen, carbon monoxide, carbon dioxide, nitrogen, methane, and a light hydrocarbon gas.

7. The separation and recovery system of claim 6, wherein the polymer separation membrane is made of at least one kind selected from the group consisting of polysulfone, polyimide, and polybenzimidazole.

8. The separation and recovery system of claim 1, wherein the adsorbent is at least one kind selected from the group consisting of zeolite, a carbon molecular sieve, activated carbon, alumina, and silica gel.

9. A separation and recovery method of hydrogen from a coke oven gas (COG) in a steel industry, comprising:
a pre-processing process of removing impurities comprising tar, moisture, oil, hydrogen sulfide, and dusts from the coke oven gas (COG);
a membrane separation process of generating a hydrogen concentrated gas stream by membrane-separating the coke oven gas (COG) processed in the pre-processing process by using a polymer separation membrane module; and
an adsorption process of separating and recovering the hydrogen by allowing the hydrogen concentrated gas stream to contact an absorbent.

10. The separation and recovery method of claim 9, wherein the polymer separation membrane module selectively separates the hydrogen from a mixed gas containing hydrogen, carbon monoxide, carbon dioxide, nitrogen, methane, and a light hydrocarbon gas.

11. A concentration method of hydrogen from a coke oven gas (COG) in a steel industry, comprising:
a pre-processing process of removing impurities comprising tar, moisture, oil, hydrogen sulfide, and dusts from the coke oven gas (COG);
a membrane separation process of generating a hydrogen concentrated gas stream by membrane-separating the coke oven gas (COG) processed in the pre-processing process by using a polymer separation membrane module; and
an adsorption process of separating and recovering the hydrogen by allowing the hydrogen concentrated gas stream to contact an absorbent.

12. The concentration method of claim 11, wherein the polymer separation membrane module selectively separates the hydrogen from a mixed gas containing hydrogen, carbon monoxide, carbon dioxide, nitrogen, methane, and a light hydrocarbon gas.
